(19) United States
(12) Patent Application Publication
(10) Pub. No.: US 2016/0316397 A1
(43) Pub. Date: Oct. 27, 2016

(54) METHODS AND SYSTEMS FOR USING USER CATEGORIZATION FOR CHANNEL ACCESS

(71) Applicant: Spreadtrum Hong Kong Limited, Central (CN)

(72) Inventor: Anna Pantelidou, Oulu (FI)

(21) Appl. No.: 14/710,884

(22) Filed: May 13, 2015

Related U.S. Application Data
(60) Provisional application No. 62/153,227, filed on Apr. 27, 2015.
(60) Provisional application No. 62/153,223, filed on Apr. 27, 2015.
(60) Provisional application No. 62/153,218, filed on Apr. 27, 2015.

(51) Int. Cl. H04W 28/24; H04W 28/20

(52) U.S. Cl. CPC H04W 28/24; H04W 28/20; H04W 84/12

(57) ABSTRACT

Various systems, methods, and non-transitory computer-readable mediums for providing a quality of service (QoS) level for communication between a wireless device and a wireless local area network (WLAN) are provided. A user classification may be determined for a user associated with a wireless device. An access class (AC) associated with a set of data to be exchanged between the wireless device and the access point (AP) of the WLAN may be determined. Using the user classification and the AC associated with the set of data to be exchanged between the wireless device and the access point of the WLAN, a priority of the set of data may be established. The set of data may be exchanged between the wireless device and the access point of the WLAN in accordance with the determined priority.

### CROSS-REFERENCES TO RELATED APPLICATIONS

This application claims the benefit of U.S. Provisional Application No. 62/153,227, filed Apr. 27, 2015, entitled INTRODUCING USER CATEGORIZATION IN CHANNEL ACCESS, the entire disclosure of which is hereby incorporated by reference for all purposes. This application claims the benefit of U.S. Provisional Application No. 62/153,223, filed Apr. 27, 2015, entitled QCI USAGE AND SIGNALING FOR IP FLOW SELECTION, the entire disclosure of which is hereby incorporated by reference for all purposes. This application claims the benefit of U.S. Provisional Application No. 62/153,218, filed Apr. 27, 2015, entitled LTE-WLAN TRAFFIC OFFLOADING ENHANCEMENT USING EXTENDED BSS LOAD ELEMENT, the entire disclosure of which is hereby incorporated by reference for all purposes.

### BACKGROUND

Future wireless network operators face various challenges, which can include capacity issues. Such capacity issued may be due to the volume of wireless devices increasing and the data requested by such devices (e.g., video, audio) also increasing. Technological methods to increase total bandwidth may, at least at times, fall short of achieving a sufficient data exchange rate to satisfy all needs of multiple users simultaneously. As such, allocation of the finite resources of network bandwidth, both in the cellular networks and local area networks (LANs) may be used to alleviate resources being overcommitted.

### SUMMARY

The present disclosure is directed to various aspects of quality of service (QoS) for wireless network communication. More specifically, aspects of this document can be related to 3GPP (Third Generation Partnership Project) and non-3GPP network interworking. Aspects of the present disclosure may enhance the HCF operation in 802.11-2012 and in particular the Enhanced Distributed Channel Access (EDCA) in order to differentiate among not only different access classes (AC) but also (or alternatively) among different users. On a cellular network, users can have different priorities. If an offload occurs by transferring a session between a wireless device and the cellular network to being between a wireless local area network and the wireless device, the wireless local area network may not be able to prioritize users in relation to each other. Conventionally, each user on wireless local area network may receive the same access probabilities irrespective of its identity, priority, device type. Conventionally, a user may only be given different access probabilities depending on the access class of the traffic it transmits. Arrangements detailed herein may allow users with different priorities (e.g., different subscriptions with a given operator cellular operator or different device types, etc.) to be given varying priority on a wireless local area network (WLAN). While this disclosure is applicable to 3GPP cellular networks, such as long-term evolution (LTE) networks, and the interplay with WLANs following partial or complete traffic offloading or handoff from the cellular network to the WLAN, the present disclosure can also enhance the general operation of various network specifications, such as IEEE's 802.11, or other amendments based on it, to support different access parameters on a user-by-user prioritized basis.

Although the present disclosure is not so limited, a method for providing a quality of service (QoS) level for communication between a wireless device and a wireless local area network (WLAN) is contemplated. The method may include or comprise: identifying a user classification that establishes priority of a user based on one or more characteristics of the user to be exchanged between the wireless device and an access point (AP) of the WLAN; defining an access class (AC) for data to be exchanged between the wireless device and the AP of the WLAN, wherein the AC is based on a category of data being transmitted between the wireless device and the AP; determining, using the user classification and the AC associated with the set of data to be exchanged between the wireless device and the access point of the WLAN, parameters for an Enhanced Distributed Channel Access (EDCA) parameter set; transmitting the EDCA parameter set from the AP to the wireless device for use in handling prioritization of communication between the wireless device and the AP; and receiving, by the AP, from the wireless device, data transmitted in accordance with the parameters defined in the EDCA parameter set.

Additionally, or alternatively, the method may further include or comprise storing, by the AP, a defined group of user classes from which the user classification is identified. Additionally, or alternatively, transmitting the EDCA parameter set comprises transmitting a beacon message from the AP to the wireless device that comprises the EDCA parameter set. Additionally, or alternatively, only some of multiple beacon messages transmitted by the AP comprise the EDCA parameter set. Additionally, or alternatively, transmitting the EDCA parameter set comprises transmitting a message from the AP to the wireless device that comprises the EDCA parameter set, the message being selected from the group consisting of: a probe response message, an association response frame message, and a reassociation response frame message. Additionally, or alternatively, the transmitted EDCA parameter set defines access parameters for user classifications for only wireless devices connected with the AP when the content of the EDCA parameter set was determined.

Additionally, or alternatively, the method may further include or comprise transmitting, by the AP to the wireless device, an indication to implement the EDCA parameter set such that a pre-existing EDCA parameter set is used by the wireless device until the indication is received by the wireless device from the AP. Additionally, or alternatively, the method may further include or comprise determining, by the wireless device, a back-off time duration for the data based on the user classification of the EDCA parameter set. Additionally, or alternatively, transmitting the set of data between the wireless device and the access point of the WLAN in accordance with the user classification of the EDCA parameter set comprises transmitting the data when a channel is identified as idle following the determined back-off time. Additionally, or alternatively, identifying the user classification is based on a predefined ordering of wireless device types stored by the AP. Additionally, or alternatively, the method may further include or comprise based on the user classification in the EDCA parameter set, determining a duration of a transmission opportunity (TXOP) for exchange of the set of data between the wireless device and the AP of the WLAN.

Although the present disclosure is not so limited, a system for providing a quality of service (QoS) level for communication between a wireless device and a wireless local area network (WLAN) is contemplated. The system may include or comprise: an access point (AP) of the WLAN, comprising: a wireless transceiver for communicating with multiple wireless devices; and a controller configured to: identify a user classification that establishing priority of a user based on one or more characteristics of the user to be exchanged between the wireless device and an access point (AP) of the WLAN; define an access class (AC) for data to be exchanged between the wireless device and the AP of the WLAN, wherein the AC is based on a category of data being transmitted between the wireless device and the AP; determine, using the user classification and the AC associated with the set of data to be exchanged between the wireless device and the access point of the WLAN, parameters for an Enhanced Distributed Channel Access (EDCA) parameter set; transmit, via the wireless transceiver, the EDCA parameter set from the AP to the wireless device for use in handling prioritization of communication between the wireless device and the AP; and receive, by the AP, from the wireless device, data transmitted in accordance with the parameters defined in the EDCA parameter set.

Additionally, or alternatively, the controller is further configured to: store a defined group of user classes from which the user classification is identified. Additionally, or alternatively, transmitting the EDCA parameter set comprises the controller of the AP causing the wireless transceiver of the AP to transmit a beacon message from the AP to the wireless device that comprises the EDCA parameter set. Additionally, or alternatively, the controller is configured such that only some of multiple beacon messages transmitted by the AP comprise the EDCA parameter set. Additionally, or alternatively, transmitting the EDCA parameter set comprises the controller of the AP causing the wireless transceiver of the AP to transmit a message that comprises the EDCA parameter set, the message being selected from the group consisting of: a probe response message, an association response frame message, and a reassociation response frame message.

Additionally, or alternatively, the transmitted EDCA parameter set defines access parameters for user classifications for only wireless devices connected with the AP when the content of the EDCA parameter set was determined. Additionally, or alternatively, the controller of the AP is further configured to cause the AP to transmit an indication to implement the EDCA parameter set such that a pre-existing EDCA parameter set is used by the wireless device until the indication is received by the wireless device from the AP. Additionally, or alternatively, the system further comprises the wireless device, the wireless device having a controller configured to determine a back-off time duration for the data based on the user classification of the EDCA parameter set. Additionally, or alternatively, the AP transmitting the set of data between the wireless device and the access point of the WLAN in accordance with the user classification of the EDCA parameter set comprises the controller of the AP being configured to cause the data to be transmitted when a channel is identified as idle following the determined back-off time. Further areas of applicability of the present disclosure will become apparent from the detailed description provided hereinafter. It should be understood that the above summary, and the following detailed description and specific examples, while indicating various embodiments, are intended for purposes of illustration only and are not intended to necessarily limit the scope of the disclosure.

### BRIEF DESCRIPTION OF THE DRAWINGS

FIG. 1 illustrates an embodiment of a cellular to WLAN handoff system.

FIG. 2 illustrates an embodiment of a method for prioritizing WLAN traffic based on a user classification.

FIG. 3 illustrates an embodiment of a method for prioritizing WLAN traffic based on a user classification following handoff or offloading from a 3GPP network to the WLAN.

FIG. 4 illustrates an embodiment of a computer system.

### DETAILED DESCRIPTION

On a WLAN, it may be useful to prioritize one or more particular user's traffic over the traffic of one or more other particular users. Such prioritization may be performed for various reasons, such as the differentiation in the types of devices the users are using to communicate with the WLAN, the various power management schemes of the devices, a subscription level, premium, or fee paid by some of the users. As a particular example, it may be beneficial for a cellular network provider to be able to handoff or offload data traffic between a cellular network node (e.g., an eNode B) and user equipment (UE), which can be any form of wireless device capable of communicating with the cellular network. Handoff refers to moving all traffic from one technology to another and maintaining connection only to a single technology (i.e., disconnecting from the first technology) while traffic offloading refers to a portion of the traffic being directed to another technology, such that the wireless device communicates with both cellular network and some other technology (e.g., a WLAN using a different communication protocol). Note that a special case of traffic offloading allows all the traffic or none of the traffic to be offloaded. The distinctive difference from handoff is though that connection to both technologies is maintained. Such a handoff or offload of a data exchange may involve an exchange of data being routed between a WLAN and the UE (which can instead be referred to as a STA) rather than between the UE and an eNB. For example, a UE's active video and/or audio session (e.g., a streaming movie, phone call) may be handed off from the cellular network to a WLAN if the cellular network experiences high bandwidth usage. When such a handoff occurs it may be desirable to ensure a quality of service for the user. Based on the user's subscription with the cellular provider, the user's device type, or some other parameter in addition or lieu of a data type may be used to establish a priority of a data exchange with the wireless device. For instance, if two STAs are both exchanging voice data, WLAN protocols, such as 802.11 ac may not dictate which STA has priority. However, by introducing a user priority parameter to the protocol used for negotiation and communication between the access point (AP) of the WLAN and the STAs, priority can be given to one of the STAs based on a factor beyond just the type of data being exchanged. As an example, in the case of 3GPP-WLAN interworking, if the user associated with a first UE has a more expensive subscription with the cellular provider, the first UE device may be assigned a higher priority. This higher priority may translate to the first STA having a shorter back-off time duration (which increases the likelihood that the first STA's high-priority data will be exchanged) during EDCA. Additionally or alternatively, this higher priority may translate into longer transmission opportunities (TXOP) for the first STA, thus translating into a higher throughput of data exchanged between the WLAN's AP and the first STA. A TXOP is an interval of time that is either assigned to a QoS STA by the hybrid coordinator (HC) at the AP or that is obtained by the STA through contention. During this interval, the STA can transmit multiple frames as long as those do not exceed a maximum duration associated with the TXOP. A TXOP is obtained per AC and therefore only traffic corresponding to this AC can be transmitted in it.

While embodiments detailed herein can be applicable to IEEE's 802.11 standards, the features or aspects of the present disclosure may be implemented in relation to other specifications as well. Specifically, embodiments detailed herein are relevant to 3GPP-WLAN interworking, which has been under discussion in 3GPP, see for example the following technical specifications released by 3GPP, 3GPP TR23.861, 3GPP TS23.402, 3GPP TS24.302, 3GPP TS24.312.

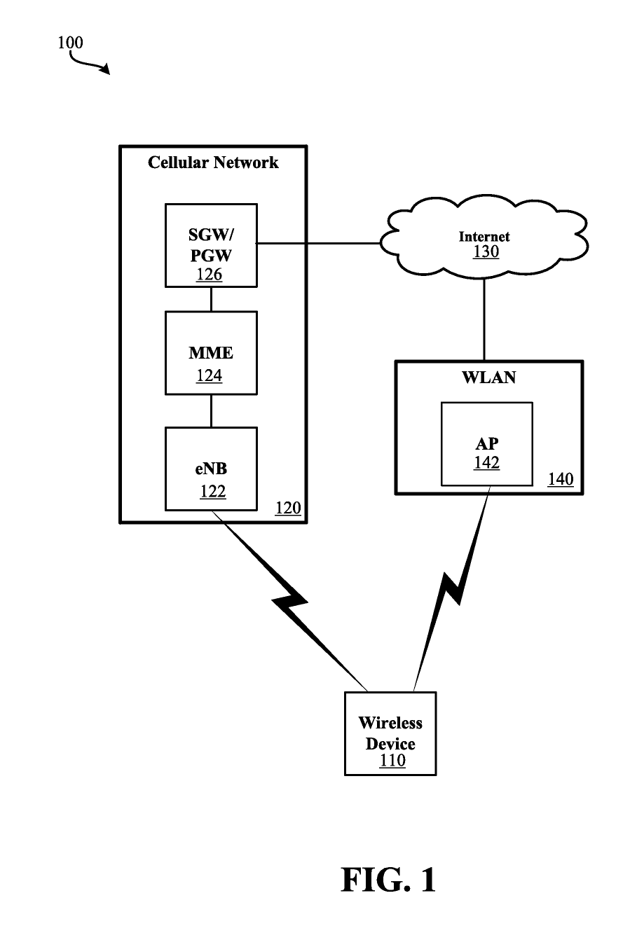

As previously mentioned, prioritization of a user on a WLAN can be used in various contexts. For instance, during a session where user equipment (e.g., any type of wireless computerized device) connects with the WLAN and exchanges data, prioritization as detailed herein can be used. As a particular example, prioritization can be used following a handoff of a communication session with the UE from a cellular network to the WLAN. Referring to FIG. 1, a cellular to WLAN handoff system 100 is presented. Cellular network 120 may represent a 3GPP network, such as an LTE cellular network. Cellular network 120 may include an eNode B (eNB) 122. eNB 122 may serve to communicate directly via wireless communication with a user's wireless device (UE) 110, similar to a base station in other forms of wireless networks. eNB 122 is in communication with Mobility Management Entity (MME) 124: MME 124 can be understood as a control-node for the LTE network. MME 124 can be responsible for idle mode paging and tagging procedure for UEs. SGW/PGW 126 (Serving Gateway/PDN Gateway) can handle handoff tasks and connectivity with external packet data networks. SGW/PGW 126 may communicate with Internet 130. Each of eNB 122, MME 124, and SGW/PGW 126 may be computerized nodes of the cellular network.

Wireless device 110, which may represent a UE, is capable of communicating wirelessly with eNB 122 (or some other form of base station) and an AP 142 of WLAN 140. When within range of AP 142, cellular network 120 may offload a voice, video, or data exchange between eNB 122 and wireless device 110 to AP 142 of WLAN 140. This may cause data to be routed via WLAN 140 to Internet 130 (or some other location) rather than via cellular network 120. When wireless device 110 is in communication with AP 142, wireless device 110 may be referred to as a “STA” rather than “UE.”

For a subscription-based cellular network, such as an LTE cellular network 120, a user may have different choices of subscription levels or plans. Such levels or plans may correspond to an agreement made with the operator, and which are typically associated with different cost schemes. A few such examples include a) 2G rates, b) 3G rates, c) 4G rates, d) 4G rates up to 1 GB, etc. Even though an LTE user is able to choose his plan and receive different “treatment” and “privileges” in the network this is not the case in current WLAN implementations. Conventionally, STAs for each WLAN user is given the same probability of accessing the channel through a unified selection of the back-off time and contention window. In WLANs, there may be users operating STAs located in more advantageous locations (e.g., users located closer to the AP) and more disadvantaged users (e.g., users located farther away from the AP, users being exposed terminals or lying inside an OBSS area) but there is no classification of a WLAN user with respect to a plan, subscription level, or other factor that can be controlled by a service provider (e.g., the cellular service provider) distinct from a data type classification.

IEEE's 802.11(e)-2005 standard, for example, defines QoS enhancements for QoS users. The hybrid coordination function (HCF) of the said standard defined as a means for that. HCF is built based on two channel access methods: a contention-based method referred to as EDCA and a controlled-channel access called HCF (hybrid coordination function) controlled channel access (HCCA). For each of these two channel access methods, IEEE's 802.11(e)-2005 defines the notion of a TXOP. TXOPs obtained during contention-based access are called EDCA TXOPs and the ones obtained during control channel access are called HCCA TXOPs. Furthermore, HCCA TXOPs obtained from the HCF to a STA through a QoS(+)CF-Poll message are called Polled TXOPs. The QoS+CF-Poll message further defines the Duration of the Polled TXOP.

As defined in IEEE's 802.11(e)-2005 standard, EDCA defines four ACs that are mapped to eight user priorities so that different access rights are given to the type of traffic that is being transmitted or received. These ACs comprise voice, video, background, and data (“best effort”). The mapping of access classes to user priorities is shown in Table 1. Therefore, in accordance with IEEE's 802.11(e)-2005 standard, user priority is based on the type of data being exchanged, but not based on any specifics of the user operating the STA or the user account associated with the STA.

TABLE 1

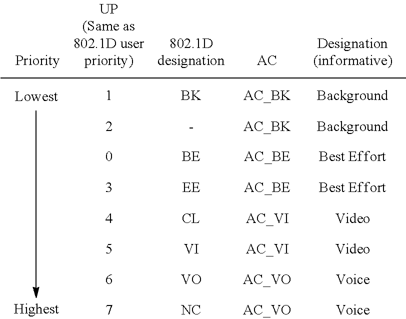

IEEE's 802.11(e)-2005 standard allows the HCF to have: 1) a different idle duration time that depends on the AC requesting transmission instead of the constant DIFS; 2) different minimum contention window limits (aCWmin and aCWmax) which also depend on the AC for which the TXOP is obtained or which requests channel access, 3) a different TXOP limit depending on the AC for which access to the medium is obtained. Thus, EDCA as implemented in IEEE's 802.11(e)-2005 standard can provide differentiated access based on the data type designation. Thus, conventionally, all MAC service data units (MSDUs) with the same priority belong to the same traffic category. The access parameters are defined per AC. So each MSDU belonging in the same AC is sent using the same parameters CWmin[AC], CWmax[AC], AIFS[AC], etc.

The function in EDCA that contends to obtain TXOPs is the enhanced distributed coordination function (EDCF). EDCF uses EDCA parameters to access the channel. When communication is outside the context of the basic service set (BSS), the EDCA parameters either take the default values, such as shown below in Table 2, or are set by the station management entity (SME) in a table, such as the dot11EDCATable, using IEEE's 802.11(e)-2005 standard as an example.

TABLE 2

| | | | | TXOP Limit |
|---|---|---|---|---|
| | | | | OFDM/CCK- |
| AC | CWmin | CWmax | AIFSN | OFDM PHY |
| AC_BK | aCWmin | aCWmax | 9 | 0 |
| AC_BE | aCWmin | aCWmax | 6 | 0 |
| AC_VI | (aCWmin + 1)/2 − 1 | aCWmin | 3 | 0 |
| AC_VO | (aCWmin + 1)/4 − 1 | (aCWmin + | 2 | 0 |
| | | 1)/2 − 1 | | |

When communication is within the BSS, the EDCA parameters may be either set by the EDCA parameter set element received from the AP (e.g., through Beacon frames), or if no EDCA parameter set element is specified then they take the default values, such as presented in Table 3, as an example.

TABLE 3

| | | | | TXOP limit | | |
|---|---|---|---|---|---|---|
| | | | | | For PHYs defined | |
| | | | | For PHYs defined | in Classes 18, | |
| | | | | in Classes 16 and | Classes 19, and | Other |
| AC | CWmin | CWmax | AIFSN | Classes 17 | Classes 20 | PHYs |
| AC_BK | aCWmin | aCWmax | 7 | 0 | 0 | 0 |
| AC_BE | aCWmin | aCWmax | 3 | 0 | 0 | 0 |
| AC_VI | (aCWmin + 1)/2 − 1 | aCWmin | 2 | 6.016 ms | 3.008 ms | 0 |
| AC_VO | (aCWmin + 1)/4 − 1 | (aCWmin + 1)/2 − 1 | 2 | 3.264 ms | 1.504 ms | 0 |

An AP can send the EDCA Parameter Set Element to STAs in selected Beacon frames, in all Probe Response and (Re)Association Response frames. The EDCA Parameter set (which, for example, can be as defined in Section 8.4.2.31 of IEEE 802.11-2012) is shown in Table 4.

TABLE 4

| | | | | | AC_BE | AC_BK | AC_VI | AC_VO |
|---|---|---|---|---|---|---|---|---|
| | | Length | QoS | | Parameter | Parameter | Parameter | Parameter |
| | Element ID | (18) | Info | Reserved | Record | Record | Record | Record |
| Octets: | 1 | 1 | 1 | 1 | 4 | 4 | 4 | 4 |

The fields AC_BE, AC_BK, AC_VI, and AC_VO in Table 4 are four octets each and have the same structure as shown in Table 6.

TABLE 6

| | | ECWmin/ | |
|---|---|---|---|
| | ACI/AIFSN | ECWmax | TXOP Limit |
| Octets: | 1 | 1 | 2 |

The “ACI/AIFSN” of Table 6 may be as appears in Table 7.

TABLE 7

| | | | | | |
|---|---|---|---|---|---|
| B0 | B3 | B4 | B5 | B6 | B7 |

| | | | | |
|---|---|---|---|---|
| | AIFSN | ACM | ACI | Reserved |
| Bits: | 4 | 1 | 2 | 1 |

In Table 7, “AIFSN” refers to a number of slots after SIFS that a STA must wait before starting a back-off or a transmission. For example, a minimum value may equal two for a non-AP STA and may equal one for an AP. “ACM” may be set to 1 to indicate that Admission Control is mandatory for this AC and has to be used before any transmission. Otherwise it may be set to 0. “ACI” may indicate the mapping between ACI and AC, as shown in Table 8:

TABLE 8

| ACI | AC | Description |
|---|---|---|
| 00 | AC_BE | Best effort |
| 01 | AC_BK | Background |
| 10 | AC_VI | Video |
| 11 | AC_VO | Voice |

The field ECWmin/ECWmax (contention window values) is shown in Table 9:

TABLE 9

| | | | |
|---|---|---|---|
| B0 | B3 | B4 | B7 |

| | | |
|---|---|---|
| | ECWmin | ECWmax |
| Bits: | 4 | 4 |

ECWmin and ECWmax fields

The values ECWmin and ECWmax encode the minimum and maximum contention window values in an exponential form such that:

CWmin=2^{ECWmin}−1 Equation 1:

CWmax=2^{ECWmax}−1 Equation 2:

The TXOP Limit field in Table 6 may be an unsigned integer in units of 32 μs that gives the maximum duration of a TXOP, namely the amount of time that a TXOP holder can have uninterrupted time to transmit on the channel. A value of zero indicates that for example the TXOP holder can send a single MSDU, MMPDU, A-MPSU, A-MPDU, any acknowledgement, any frames required for protection, any frames required for beamforming, any frames required for link adaptation, any number of BlockAckReq. To obtain an EDCA TXOP, the value of AIFSN (arbitration interframe spacing number) in Table 7 is needed in order to compute the amount of time to wait (AIFS) before back-off is performed.

AIFS[AC]=AIFSN[AC]×aSlotTime+aSIFSTime. Equation 3:

The minimum and maximum contention window values CWmin[AC] and CWmax[AC] depend on the AC that requests access. To handle retransmissions, there may be a short and long retry counter defined per AC, QSRC[AC] and QLRC[AC] respectively. The initial values of both counters are equal to 0. The value of QSRC[AC] can be incremented every time an A-MPDU or a frame of length smaller than or equal to dot11RTSThreshold fails. The value of QLRC[AC] is increased every time an A-MPDU or a frame with length larger than dot11RTSThreshold fails. Both counts are reset every time the corresponding type of frames they count succeeds.

The parameters detailed above may be enhanced in order to allow particular STAs or users priority over others. As mentioned above, the features or aspects of the present disclosure may enhance the HCF operation in IEEE's 802.11-2012 and in particular EDCA in order to further differentiate not only among different ACs, but also among users of different classes, for example users with different subscriptions with a given operator or different device types or users with different priorities in general when the STA is communicating with an AP, such as AP 142 of WLAN 140. The HCF enhancement may be generalized to encompass enhancements both independently of interworking (without signaling from the 3GPP network) and also signaled by the 3GPP network.

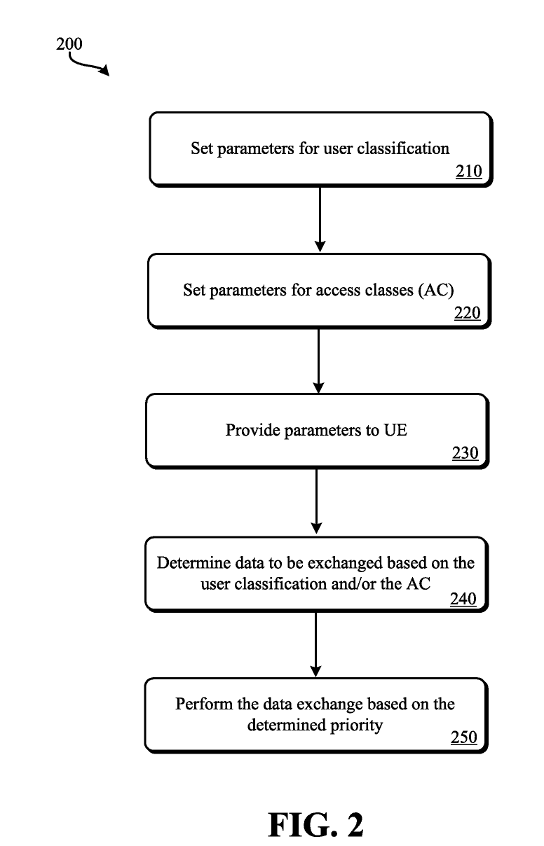

FIG. 2 illustrates an embodiment of a method 200 for prioritizing WLAN traffic based on a user classification. Referring to FIG. 1, method 200 may be performed in system 100, involving offloading or handoff signaling between cellular network 120 and AP 142. Alternatively, it may be possible for method 200 to be performed without signaling between cellular network 120 and AP 142. For instance, method 200 may be performed irrespective of any cellular network handoff (that is, user priority may be used and defined even when a handoff from a cellular network is not involved).

At block 210 of method 200, user classification parameters may be set in the EDCA parameter set for the wireless device (STA) that is communicating with the AP of the WLAN. This user classification may be identified by the AP for use in setting the EDCA parameter set. The user classification may supplement an AC designation in data exchange between the AP and two STAs is to occur for the same data type, the user classification can be used to prioritize a particular STA (associated with a higher priority user) over another STA. To identify the user classification, the AP may be provided with information. For instance, in some embodiments, cellular network 120, such as SGW/PGW 126 may provide an indication to AP 142 via Internet 130 of a user classification associated with wireless device 110. For instance, if wireless device 110 is being handed off to AP 142, cellular network 120 may perform a look-up of a user priority associated with wireless device 110 from a database accessible by cellular network 120 to determine the user priority. Cellular network 120 may then transmit an indication to WLAN via Internet 130 or via wireless device 110 indicative of the user priority. As a simple use case, the more expensive the user's subscription with the cellular provider, the higher a user priority may be assigned by the cellular provider and signaled to the AP.

Table 10 below illustrates an exemplary modified EDCA parameter set that includes a user classification octet “User Classes/Subscription Plans.”

TABLE 10

| | | | | User | | | | | | | | | |
|---|---|---|---|---|---|---|---|---|---|---|---|---|---|
| | | | | Classes/ | AC_BE | AC_BK | AC_VI | AC_VO | | AC_BE | AC_BK | AC_VI | AC_VO |
| | Element | Length | QoS | Subscription | Parameter | Parameter | Parameter | Parameter | | Parameter | Parameter | Parameter | Parameter |
| | ID | (18) | Info | Plans | Record1 | Record1 | Record1 | Record1 | . . . | Record8 | Record8 | Record8 | Record8 |
| Octets: | 1 | 1 | 1 | 1 | 4 | 4 | 4 | 4 | | 4 | 4 | 4 | 4 |

This exemplary EDCA replaces an unused “reserved” octet with user classification data that can be used to prioritize a user's STA data traffic over another user's STA data traffic. The position of different bits in the user classification octet may indicate the priority: Bit 0—legacy STA; Bit 1—2G; Bit 2—3G; Bit 3—4G; Bit 4—5G; and Bits 5-7—reserved. Such an embodiment is merely exemplary, other data formats are possible. Depending on the implementation, this new data field can be defined as mandatory or optional. Beacon frames, (Re)Association Response, Probe Response frames or any other frames containing the new EDCA Parameter Set Element can be signaled by using the reserved bits in the Type/Subtype field of frame control field can be used to indicate the new frame types, e.g., Type b3b2=11, Subtype=0000-1111. To be clear, internal data collisions at the STA may still be handled exclusive of the user classification (since each piece of data would have the same user classification).

In some embodiments, the AP may send access information about all possible “user classes” or alternatively knowing the user classes of each associated STA in its network, the AP can send information for those only classes for which STAs are present. This can reduce the size of the modified EDCA parameter set field. Alternatively, the full sized modified EDCA parameter set field can be sent in one or more beacon transmissions that can be longer in size but sent with less frequency. Also, such information can be sent, for example, in Probe Response messages that come as a response to a Probe Request in order to inform the inquiring STA about the different access parameters for various user classes in the network.

In some embodiments, if the AP is not signaled as to a particular user classification for STA, predefined priorities stored or otherwise accessible by the AP may be used. For instance, the AP may determine a type of device for the STA (e.g., tablet, computer, smartphone, sensor) and assess a user classification based on the device type using a predefined (stored) device priority ordering. For example, it may be desirable for the AP to put devices with more stringent energy requirements in the a high priority user classification to allow them to transmit ahead of other devices and thus waste less energy performing back-off. The AP may also maintain a maximum fixed number of various user classifications. For instance, the AP may only permit a maximum of one STA (or some other number of STAs) to have the highest user classification.

In some embodiments, while the user classification parameters are set in the EDCA parameter set by the AP, the STA will identify its user classification based upon data received from the cellular network or data stored locally at block 210.

At block 220, access class parameters may be set by the AP in the EDCA parameter set for the wireless device (STA) that is communicating with the AP of the WLAN. The relationship between access class and ACI may be set as previously detailed in relation to the EDCA parameter set. The STA itself may identify the AC associated with data it is to transmit via the wireless channel to the AP in accordance with the EDCA parameter set received from the AP.

At block 230, the various parameters, such as the EDCA parameter set, which can include both parameters to prioritize data based on AC and a parameter to prioritize data based on user classification may be transmitted by the AP to the STA. These access parameters can be sent in Beacon, Probe Response, and (Re)Association Response frames that are sent by the AP to the STA.

At block 240, the AP may use the EDCA parameter set to evaluate during EDCA which data should be transmitted and at what time according to the EDCF. Based on the defined user priority and the access class, data may be transmitted prior to other data destined for different STA or the same STA but having a lower AC. Additionally or alternatively, at block 240, the STA may use the received EDCA parameter set to evaluate how and when data should be handled for data transmission to the AP. Based on the defined user priority and the access class, data may be transmitted following a shortened backoff period and longer TXOP duration, thus allowing data to be transferred ahead of other data (both originating at the same STA and data that would be transmitted from other STAs to the AP). At block 250, data may be exchanged between the AP and STA (e.g., transmitted from the AP to the STA, transmitted from the STA to the AP) in accordance with the determination of block 240.

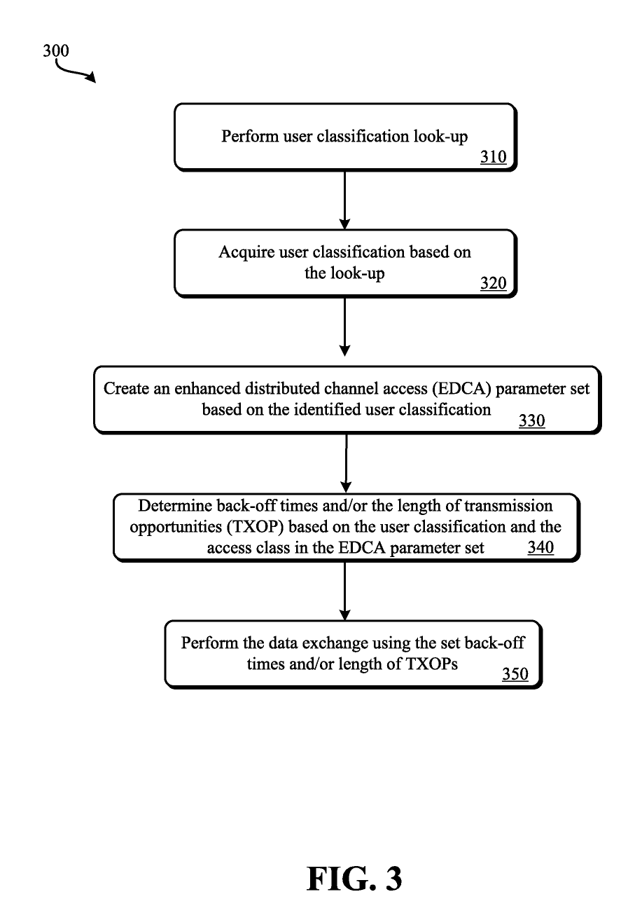

FIG. 3 illustrates an embodiment of a method 300 for prioritizing WLAN traffic based on a user classification following an offload or handoff from a 3GPP network (e.g., an LTE cellular network). Referring to FIG. 1, method 200 may be performed in system 100, involving signaling between cellular network 120 and AP 142.

At block 310, the 3GPP network may determine a user classification by performing a database lookup. In some embodiments, the 3GPP network may assign a user classification based on the type of connection the UE has with the 3GPP network (e.g., 2G, 3G, 4G, etc.). In some embodiments, the database may be used to determine a subscription level paid by the user: the higher the subscription level, the higher of priority a user classification will be assigned. At block 320, the user classification may be acquired via the look-up. At block 330, the user classification may be identified to the AP of the WLAN. This may involve data being transmitted from the 3GPP network to the AP of the WLAN via the Internet (not via the UE/STA) or from the 3GPP network to the UE and relayed to the AP. The UE may additionally or alternatively store or determine its own priority and may provide such information to the AP.

At block 330, the various parameters, including the user classification, may be used to create a data set, such as an EDCA parameter set, which can include both parameters to prioritize data based on AC and a parameter to prioritize data based on user classification may be transmitted by the AP to the STA. Block 330 may be performed by the AP and may take into account factors such as the number of UEs that have an associated user classification. These access parameters can be sent in Beacon, Probe Response, and (Re)Association Response frames that are sent by the AP to the STA. If a parameter dot113GPPInterworking is set then the new EDCA parameter set element may be included in the Beacon, Probe Response and (Re)Association Response frames while, otherwise, if dot113GPPInterworking is not set then the old EDCA parameter set element may be used.

At block 340, based on the EDCA parameter set created using the user classification, back-off times and TXOPs may be determined for an exchange of data between the STA and the AP in accordance with the EDCF. The user classification values can affect the back-off times and TXOPs used between the STA and AP for the data exchange, thus causing the data transfer to be prioritized ahead of data transfers between the AP and other UEs while in an EDCA transfer mode. For example, a user belonging in a user class of higher priority may obtain longer TXOPs for a given AC as opposed to another user belonging to a class of a lower priority. As another example, a user belonging in a user class of higher priority may have smaller CWmin and CWmax contention window values as opposed to a user belonging to a user class with lower priority in order to transmit a given AC. As another example, a user belonging in a user class of higher priority may have smaller AIFSN value as opposed to a user belonging to a user class with lower priority. As a final example, a higher priority user's STA may have to wait a smaller amount of time before back-off is performed.

At block 350, data exchange between the AP and the STA may be performed based on the back-off times and/or length of TXOPs determined based on the EDCA parameter set. Since the amount of backoff time is less and/or the TXOPs are longer in duration based on the user classification, the STA associated with the greater user classification/priority will experience a greater data throughput with the AP.

While the above embodiments are focused on parameters that used in reference to IEEE's 802.11 standard set, it should be understood that the principles detailed herein can be applied to other wireless and wired communication standards.

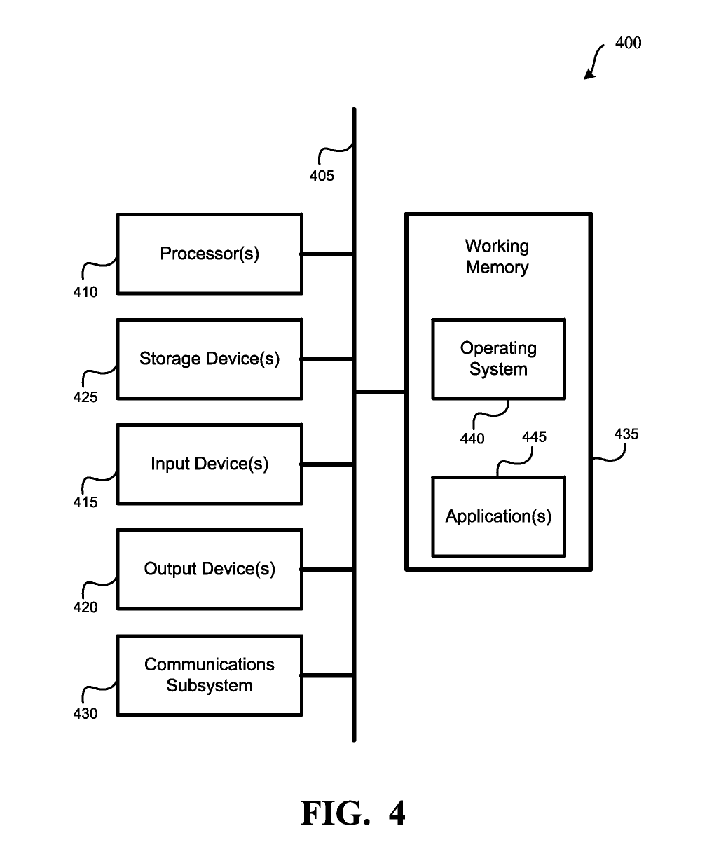

A computer system as illustrated in FIG. 4 may be incorporated as part of the previously described computerized devices, such as the wireless device (STA), AP, eNB, and/or other components of the cellular network. FIG. 4 provides a schematic illustration of one embodiment of a computer system 400 that can perform various steps of the methods provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, video decoders, and/or the like); one or more input devices 415, which can include without limitation a mouse, a keyboard, remote control, and/or the like; and one or more output devices 420, which can include without limitation a display device, a printer, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. The communications subsystem 430 may permit data to be exchanged with a network (such as the network described below, to name one example), other computer systems, and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the non-transitory storage device(s) 425. Merely by way of example, execution of the sequences of instructions contained in the working memory 435 might cause the processor(s) 410 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 (and/or components thereof) generally will receive signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a non-transitory storage device 425 either before or after execution by the processor(s) 410.

It should further be understood that the components of computer system 400 can be distributed across a network. For example, some processing may be performed in one location using a first processor while other processing may be performed by another processor remote from the first processor. Other components of computer system 400 may be similarly distributed. As such, computer system 400 may be interpreted as a distributed computing system that performs processing in multiple locations. In some instances, computer system 400 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for providing a quality of service (QoS) level for communication between a wireless device and a wireless local area network (WLAN), the method comprising:
identifying a user classification that establishes priority of a user based on one or more characteristics of the user to be exchanged between the wireless device and an access point (AP) of the WLAN;
defining an access class (AC) for data to be exchanged between the wireless device and the AP of the WLAN, wherein the AC is based on a category of data being transmitted between the wireless device and the AP;
determining, using the user classification and the AC associated with the set of data to be exchanged between the wireless device and the access point of the WLAN, parameters for an Enhanced Distributed Channel Access (EDCA) parameter set;
transmitting the EDCA parameter set from the AP to the wireless device for use in handling prioritization of communication between the wireless device and the AP; and
receiving, by the AP, from the wireless device, data transmitted in accordance with the parameters defined in the EDCA parameter set.

2. The method for providing the QoS level for communication between the wireless device and the WLAN of claim 1, further comprising:
storing, by the AP, a defined group of user classes from which the user classification is identified.

3. The method for providing the QoS level for communication between the wireless device and the WLAN of claim 1, wherein transmitting the EDCA parameter set comprises transmitting a beacon message from the AP to the wireless device that comprises the EDCA parameter set.

4. The method for providing the QoS level for communication between the wireless device and the WLAN of claim 3, wherein only some of multiple beacon messages transmitted by the AP comprise the EDCA parameter set.

5. The method for providing the QoS level for communication between the wireless device and the WLAN of claim 1, wherein transmitting the EDCA parameter set comprises transmitting a message from the AP to the wireless device that comprises the EDCA parameter set, the message being selected from the group consisting of: a probe response message, an association response frame message, and a reassociation response frame message.

6. The method for providing the QoS level for communication between the wireless device and the WLAN of claim 1, wherein the transmitted EDCA parameter set defines access parameters for user classifications for only wireless devices connected with the AP when the content of the EDCA parameter set was determined.

7. The method for providing the QoS level for communication between the wireless device and the WLAN of claim 3, further comprising:
transmitting, by the AP to the wireless device, an indication to implement the EDCA parameter set such that a pre-existing EDCA parameter set is used by the wireless device until the indication is received by the wireless device from the AP.

8. The method for providing the QoS level for communication between the wireless device and the WLAN of claim 1, further comprising: determining, by the wireless device, a back-off time duration for the data based on the user classification of the EDCA parameter set.

9. The method for providing the QoS level for communication between the wireless device and the WLAN of claim 1, wherein transmitting the set of data between the wireless device and the access point of the WLAN in accordance with the user classification of the EDCA parameter set comprises transmitting the data when a channel is identified as idle following the determined back-off time.

10. The method for providing the QoS level for communication between the wireless device and the WLAN of claim 1, wherein identifying the user classification is based on a predefined ordering of wireless device types stored by the AP.

11. The method for providing the QoS level for communication between the wireless device and the WLAN of claim 1, further comprises: based on the user classification in the EDCA parameter set, determining a duration of a transmission opportunity (TXOP) for exchange of the set of data between the wireless device and the AP of the WLAN.

12. A system for providing a quality of service (QoS) level for communication between a wireless device and a wireless local area network (WLAN), the system comprising:
an access point (AP) of the WLAN, comprising:
a wireless transceiver for communicating with multiple wireless devices; and
a controller configured to:
identify a user classification that establishing priority of a user based on one or more characteristics of the user to be exchanged between the wireless device and an access point (AP) of the WLAN;
define an access class (AC) for data to be exchanged between the wireless device and the AP of the WLAN, wherein the AC is based on a category of data being transmitted between the wireless device and the AP;
determine, using the user classification and the AC associated with the set of data to be exchanged between the wireless device and the access point of the WLAN, parameters for an Enhanced Distributed Channel Access (EDCA) parameter set;
transmit, via the wireless transceiver, the EDCA parameter set from the AP to the wireless device for use in handling prioritization of communication between the wireless device and the AP; and
receive, by the AP, from the wireless device, data transmitted in accordance with the parameters defined in the EDCA parameter set.

13. The system for providing the QoS level for communication between the wireless device and the WLAN of claim 12, wherein the controller is further configured to:
store a defined group of user classes from which the user classification is identified.

14. The system for providing the QoS level for communication between the wireless device and the WLAN of claim 12, wherein transmitting the EDCA parameter set comprises the controller of the AP causing the wireless transceiver of the AP to transmit a beacon message from the AP to the wireless device that comprises the EDCA parameter set.

15. The system for providing the QoS level for communication between the wireless device and the WLAN of claim 12, wherein the controller is configured such that only some of multiple beacon messages transmitted by the AP comprise the EDCA parameter set.

16. The system for providing the QoS level for communication between the wireless device and the WLAN of claim 12, wherein transmitting the EDCA parameter set comprises the controller of the AP causing the wireless transceiver of the AP to transmit a message that comprises the EDCA parameter set, the message being selected from the group consisting of: a probe response message, an association response frame message, and a reassociation response frame message.

17. The system for providing the QoS level for communication between the wireless device and the WLAN of claim 12, wherein the transmitted EDCA parameter set defines access parameters for user classifications for only wireless devices connected with the AP when the content of the EDCA parameter set was determined.

18. The system for providing the QoS level for communication between the wireless device and the WLAN of claim 12, wherein the controller of the AP is further configured to cause the AP to transmit an indication to implement the EDCA parameter set such that a pre-existing EDCA parameter set is used by the wireless device until the indication is received by the wireless device from the AP.

19. The system for providing the QoS level for communication between the wireless device and the WLAN of claim 12, the system further comprising the wireless device, the wireless device having a controller configured to determine a back-off time duration for the data based on the user classification of the EDCA parameter set.

20. The system for providing the QoS level for communication between the wireless device and the WLAN of claim 12, wherein the AP transmitting the set of data between the wireless device and the access point of the WLAN in accordance with the user classification of the EDCA parameter set comprises the controller of the AP being configured to cause the data to be transmitted when a channel is identified as idle following the determined back-off time.
